(19) United States
(12) Patent Application Publication
(10) Pub. No.: US 2013/0332724 A1
(43) Pub. Date: Dec. 12, 2013

(54) User-Space Enabled Virtual Private Network

(71) Applicant: Matthew William Walters, Gilbert, AZ (US)

(72) Inventor: Matthew William Walters, Gilbert, AZ (US)

(73) Assignee: CUMMINGS ENGINEERING CONSULTANTS, INC., Chandler, AZ (US)

(21) Appl. No.: 13/688,160

(22) Filed: Nov. 28, 2012

Related U.S. Application Data
(60) Provisional application No. 61/632,457, filed on Jan. 24, 2012.

(51) Int. Cl. H04L 29/06

(52) U.S. Cl. CPC H04L 63/0471; H04L 63/08
USPC 713/153

(57) ABSTRACT

This invention includes apparatus, systems, and methods to establish a virtual private network (“VPN”), or a secured network for authenticated and encrypted data transmission to prevent disclosure of private information to unauthorized parties. This invention provides secure and authenticated data transmission from a communication device to another device over any public or private network while using existing standard applications such as email, VoIP, internet browsers, ISR applications, video conferencing, telecommuting, inventory tracking and control, etc. without the need to secure or add encryption features into each specific application. This invention provides the opportunity to selectively secure one or more existing applications with configuration changes that can be made at the user-space level of the software stack and without need for higher level software stack access, such as root access.

### CROSS-REFERENCE TO RELATED APPLICATIONS

The present application is related to and claims priority from prior provisional application Ser. No. 61/632,457 filed Jan. 24, 2012 the contents of which are incorporated herein by reference.

### FIELD OF THE INVENTION

This invention relates generally to the field of securing data, and particularly a method, apparatus, and system for encrypting and decrypting electronic data from non-secure applications while in transit via a communications network.

### BACKGROUND OF THE INVENTION

Modern electronic communication systems are used prolifically to communicate information in the form of electronic data across extensive wire and wireless communication networks. Private, corporate, and government entities use such networks to communicate sensitive information that require privacy and security. However, most public communication networks do not provide adequate means to maintain the privacy and security of data while in transit. Therefore, electronic data is vulnerable to malicious use by entities not authorized to receive the electronic data. This includes the billions of electronic transmissions sent each day via mobile and fixed communications devices such as smart phones, tablet PC's, notebook PC's, desktop PC's, or any other device that transmits over communication networks. A user-friendly, compatible, and accessible data encryption solution is needed to protect the privacy and security for the users of such devices.

Specialized networks and software applications are available to help remedy this issue, however, such remedies are too expensive, cumbersome, and incompatible for use by a significant number of devices used by the general population. Many existing encryption systems require a completely separate communications network segregated from the general population to maintain security, however, such a solution is impractical for general use. Other solutions provide highly sophisticated software applications that enable security with encryption algorithms. Unfortunately, these software applications typically require hardware and software customization at both the client and server ends. Such customization results in added user cost and limited availability to the general population. Hence, existing solutions provide limited capability to secure electronic data transmissions, but due to their inherent designs are limited for use by the general population.

An example where this issue is often encountered involves the use of devices that use the Android operating system. Android-based devices are limited in protecting electronic data because Android-based devices have limited virtual private network (“VPN”) capabilities. The Android operating system requires that users have elevated permission levels such as root permissions to install or operate VPN capabilities. Hence, existing VPN solutions have limited use on Android-based devices.

This invention provides a novel method, apparatus, and system to protect electronic data transmissions that is less cumbersome for the end user than existing solutions. This invention enables a secure communication tunnel, or VPN, on a communication device completely within the user-space of an operating system for secure transmissions over existing public communication networks. This invention is also compatible with the most prolifically used mobile communication devices and existing software applications without the need to add security into each specific application.

### BRIEF SUMMARY OF THE INVENTION

In one embodiment of the invention a system for establishing a secure communication tunnel to transmit electronic data across a communication network from a communication device with a non-secure application to a remote application system comprises a first communication device. Next a non-secure application is installed on the communication device. Next a network socket connection is coupled to the non-secure application. Next a monitor device is coupled to the network socket connection. Next a cryptographic application device is coupled to the monitor device. Next a local communication port is coupled to the cryptographic application device. Next a secure communication tunnel is connected to the local communication port and a remote communication port of the remote application system. Next the remote communication port is coupled to a second cryptographic application device. Next a server is connected to the second cryptographic application device. Next a second communication device is coupled to the server. Finally, the system is reversible so the second communication device can transmit electronic data to the first communication device over the established secure communication tunnel.

In one embodiment of the invention a method for establishing a secure and protected communication tunnel to transmit electronic data across a communication network from a communication device with a non-secure application to a remote application system comprises the first step of configuring the communication device's cryptographic application device with identifying information for a remote application system. Next a local communication port from the communication device is associated with the cryptographic application device. Next the non-secure application is configured to transmit data through a specific network socket connection. Next the cryptographic application device establishes a secure and authenticated connection to a second cryptographic application device of the remote application system. Next a monitor monitors data transmitted through the network socket connection. Next the monitor directs the data to the cryptographic application device. Next the cryptographic application device prepends the data with the identifying information for the remote application system. Next the cryptographic application device encrypts the appended data. Next the encrypted data is transmitted via the secure and authenticated connection to the second cryptographic application device of the remote application system. Next the second cryptographic application device authenticates the transmission. Next the encrypted data is decrypted. Next the decrypted data is transmitted to a server. Next the server uses the identifying information to determine the second communication device. Finally, the communication method is reversible and the second communication device can transmit electronic data to the first communication device over the established secure communication tunnel.

### BRIEF DESCRIPTION OF THE DRAWINGS

Features and advantages of the claimed subject matter will be apparent from the following detailed description of embodiments consistent therewith, which description should be considered with reference to the accompanying drawings, wherein:

FIG. 1 is a diagram illustrating how a typical VPN is set up on a communications device in accordance with known prior art;

FIG. 2 is a diagram of an exemplary embodiment for establishing a VPN in accordance with the teachings of the present invention;

FIG. 3 is a diagram of an exemplary embodiment for a system to establish a secure communication tunnel to transmit electronic data across a communication network from a communication device with a non-secure application to a remote application system in accordance with the teachings of the present invention;

FIG. 4 is a diagram of an exemplary embodiment for the reversible system to establish a secure communication tunnel to transmit electronic data across a communication network from the second communication device with a non-secure application back to the first communication device in accordance with the teachings of the present invention;

FIG. 5 is a diagram of an exemplary embodiment for a method to establish a secure and protected communication tunnel to transmit electronic data across a communication network from a communication device with a non-secure application to a remote application system in accordance with the teachings of the present invention.

### DETAILED DESCRIPTION OF THE INVENTION

The following describes the details of the invention. Although the following description will proceed with reference being made to illustrative embodiments, many alternatives, modifications, and variations thereof will be apparent to those skilled in the art. Accordingly, it is intended that the claimed subject matter be viewed broadly. Examples are provided as reference and should not be construed as limiting. The term “such as” when used should be interpreted as “such as, but not limited to.”

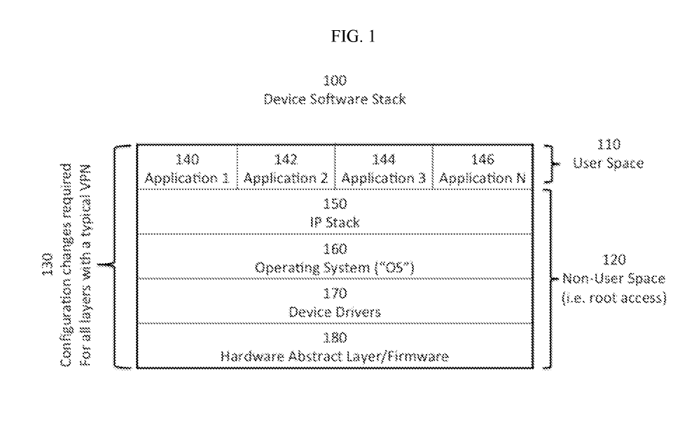

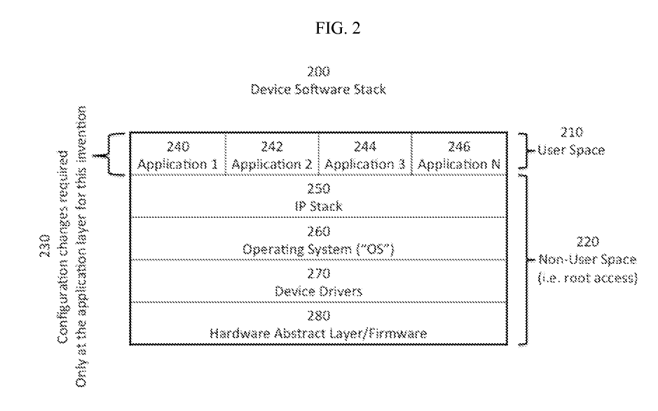

This invention enables a secure communication tunnel, or virtual private network (“VPN”), on a communication device completely within the user-space of the operating system. The invention allows a communication device with an existing non-secure software application to leverage secure and authenticated communications between the communication device and a server, or another communication device without the need for modifying the existing software application's source code. FIG. 1 illustrates the device software stack 100 for a typical VPN method which requires modifying the operating system 160, IP stack 150, device drivers 170, and hardware abstract layer/firmware 180—all of which require elevated privileges such as root privileges 120 to install or operate the VPN software on a communication device. FIG. 2 illustrates the device software stack 200 for a VPN approach embodied by this invention. This invention does not require configuration changes to the non-user space 220 of the device software stack 200. Configuration changes 230 are required only at the user-space 210 layer and no changes are required to the operating system 260, IP stack 250, device drivers 270, and hardware abstract layer/firmware 180, nor does it require root privileges 220 to install or operate. The invention may be set up on a communication device completely within the user-space 210 and with the credentials of the current device user.

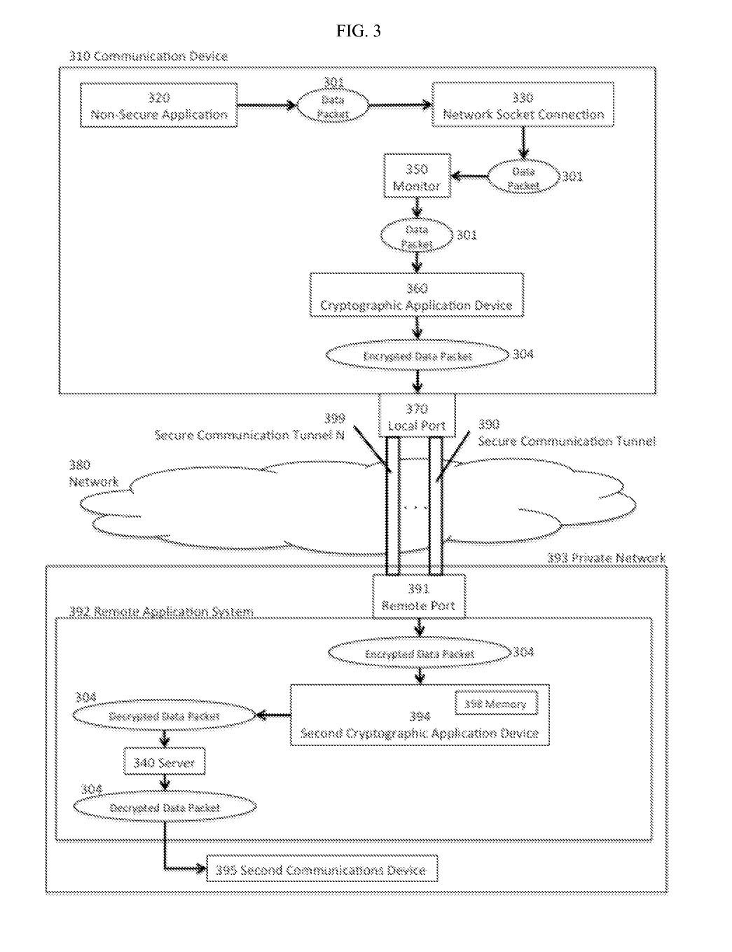

FIG. 3 is a diagram of an exemplary embodiment for a system 300 comprising a first communication device 310. The communication device 310 may include an electronic communication or computing device such as a smartphone, tablet, fixed personal computer, mobile computer, or any communication device that enables one computer or electronic device to communicate with another. Next a non-secure application 320 is installed on the communication device 310. The non-secure application 320 may include a software application installed within the software stack 321 of the communication device 310. The non-secure application 320 may be a commercially available off-the shelf (“COTS”) software application without an integrated data encryption capability. Such a non-secure application 320 may include standard software applications such as Email, SIP-based VoIP clients, and video conferencing applications or any other software application in which communicating data across a communication network is a function of the application.

Next a network socket connection 330 is coupled to the non-secure application 320. The network socket connection 330 constitutes a mechanism for delivering data packets 301 to the appropriate application process, based on a combination of local and remote IP addresses and port numbers. Each socket connection is mapped by the operating system to a communicating application process. In other words, the non-secure application 320 is configured with the network socket connection 330 with a server 340 set to local-host and a defined port. So when the non-secure application 330 attempts to connect to an external server 340, the non-secure application 320 will open up a network socket connection 330 to the local-host and the defined port.

Next a monitor device 350 is coupled to the network socket connection 330. The monitor device 350 monitors the network socket connection 330 for data packet 301 transmissions from the non-secure application 320. The monitor device 350 may be a programmable computer, electronic device, or a software application. The monitor device 350 utilizes the network socket connection 330, such as TCP and UDP sockets to accept incoming data packets 301 from the non-secure applications 320.

Next a cryptographic application device 360 is coupled to the monitor device 350. The cryptographic application device 360 retrieves the destination information for the data packet 301 from a database or predefined connection information. The destination information may include the data packet's 301 final destination information such as a destination server 340 name, IP address, port number, and device authentication information. The cryptographic application device 360 prepends the data packet 301 with the destination information and then encrypts the entire data into an encrypted data packet 304. The cryptographic application device includes a cryptographic engine consisting of hardware and, or software that utilizes a data encryption algorithm to secure data from unauthorized access. The cryptographic application device may include a stand-alone module consisting of the necessary algorithm data path and control processor chips and associated software. Likewise the cryptographic application device may be integrated within the communication device. In short, the cryptographic application device transforms the plaintext, non-encrypted data packet 301 using an encryption algorithm, or a cipher, to make the data unreadable to anyone except those possessing special knowledge, a key, to decrypt and make the data readable.

Next a local communication port 370 is coupled to the cryptographic application device 360. The local communication port 370 is coupled to a communication network 380 such as a public or private internet, telecommunications, or other network capable of transmitting electronic data packets 304. The local communication port 370 is capable of receiving encrypted data packets 304 transmitted by the cryptographic application device 360 and transmitting the encrypted data 304.

Next a secure communication tunnel 390 is connected to the local communication port 370 and a remote communication port 391 of the remote application system 392. The secure communication tunnel 390 may include a virtual private network (“VPN”) or any communication connection that uses primarily public telecommunication infrastructure, such as the Internet, to provide remote users access to a centrally organizational network, or private network. Multiple secure tunnels 399 may be established at any time allowing encrypted data 304 from various non-secure applications to transmit across more than one secure communication tunnel 399. Configuration regarding which secure communication tunnel 390 encrypted data 304 transmits across may be preconfigured or automatically established such as by random generation, or depending on which network 380 the remote application system 392 is associated with.

Next the remote communication port 391 is coupled to a second cryptographic application device 394. The secure communication tunnel 390 is coupled to the remote application system 392 via the remote communication port 391. The remote communication port 391 may be a serial port or a parallel port with such interfaces as Ethernet, FireWire, and USB or other such interface intended to interface with a communication device.

Next a second cryptographic application device 394 is coupled to the remote communication port 391 to receive the encrypted data 304. The second cryptographic application device 394 is a cryptographic engine consisting of hardware and, or software that utilizes a data encryption algorithm to secure data from unauthorized access. The second cryptographic application device 394 may include a stand-alone module consisting of the necessary algorithm data path and a control processor chips and associated software. Likewise the second cryptographic application device may be integrated within a server, computer, electronic or communication device within the remote application system 392. The second cryptographic application device 394 first authenticates the data packet 304 as one from a known and trusted source then it transforms the encrypted data 304 using a decryption algorithm, or a key, to make the data readable. With the decrypted data 307, the second cryptographic application device 394 is able to identify the data's 307 final destination information such as a destination server 340 name, IP address, port number, and device authentication information. If decryption of authentication fails, the encrypted data packet 304 is dropped. The second cryptographic application device 394 uses the data's 307 final destination information to initiate a connection to a server 340 within its private network 393. The second cryptographic application device 394 will now track this connection to the server 340 and associate it with the first communication device's 310 destination information such as the IP address and local port number to facilitate communication back to the first communication device 310. Once the connection to the server 340 is established, the second cryptographic application device 394 sends the decrypted data 307 to the server 340.

Next a server 340 is coupled to the second cryptographic application device 394. The server 340 may be a software program running to serve the computational or communication tasks of the non-secure application 320, or the server 340 may be a physical computer dedicated to running one or more applications to serve the needs of communications devices (i.e. 310 and 395) attached to the network 380. The server 340 may include an email-server, computer, server, switch, gateway, router, database server, file server, mail server, print server, web server, or other electronic or computing device capable of directing electronic data to communication devices.

Next a second communication device 395 is coupled to the server 340. The second communication device 395 may include an electronic communication or computing device such as a smartphone, tablet, fixed personal computer, mobile computer, or any communication device that enables one computer or electronic device to communicate with one another.

The invention thus far describes the remote application system 392 with discreet devices including the remote communication port 391, second cryptographic application device 394, server 340, and second communication device 395. However, these discreet devices may be integrated into fewer devices that perform the same functions as described with each discreet device. For example, the second communication device 395 may be an apparatus that included features that enable it to function as the remote communication port 391, second cryptographic application device 394, and server 395.

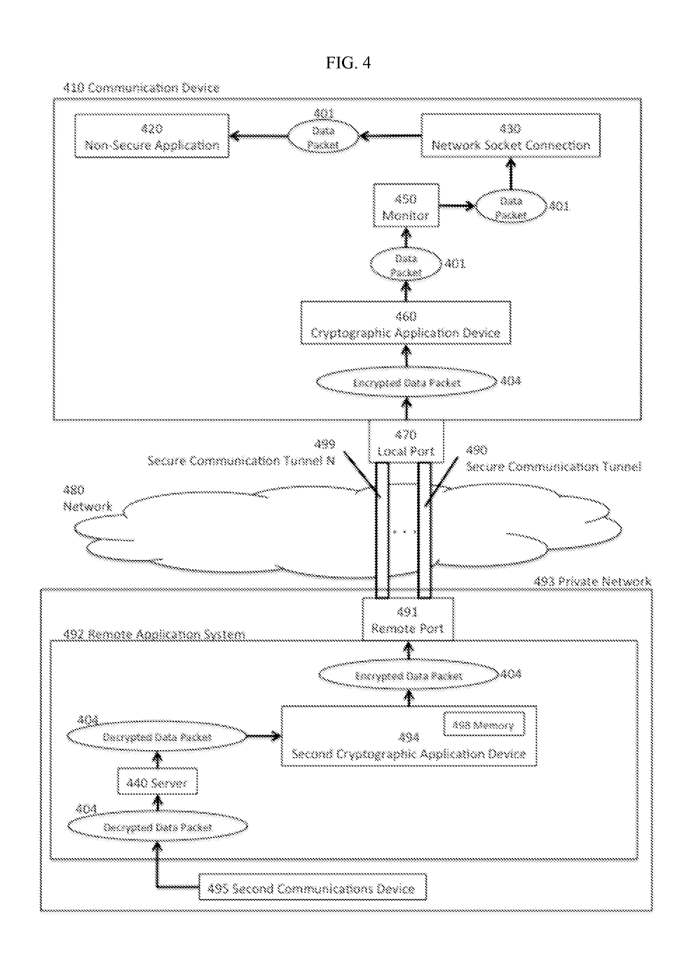

Finally as shown in FIG. 4 the system 400 is reversible so the second communication device 495 can transmit electronic data 404 to the first communication device 410 over the established secure communication tunnel 490. The entire connection is reversed when the second communication device 495 responds to the incoming data from the first communication device 410. The response data 408 is sent to the server 440 and forwarded to the second cryptographic application device 494. The second cryptographic application device 494 retrieves the first communication device's 410 destination information such as the IP address and local port number from memory 498, which it previously stored from associating the initial data transfer to the first and second communication devices 410 and 495. The second cryptographic application device 494 prepends the data 407 with the destination information and then encrypts the entire data into an encrypted data packet 404. The encrypted data packet 404 is then transmitted across the secure communication tunnel 490. The first cryptographic application device 460 authenticates the transmission as being from a known and trusted source, and then it decrypts the data 401. The encrypted data packet 404 may be discarded if the decryption or authentication fails. After decryption and authentication, the first cryptographic application device 460 transmits the decrypted data packet 401 via the associated network socket connection 430 identified within the response data 401. The monitor 450 observes the data transmission since it has been monitoring the configured network socket connection 430 and forwards the decrypted data packet 401 to the non-secure application 420 thus completing the data transmission interchange.

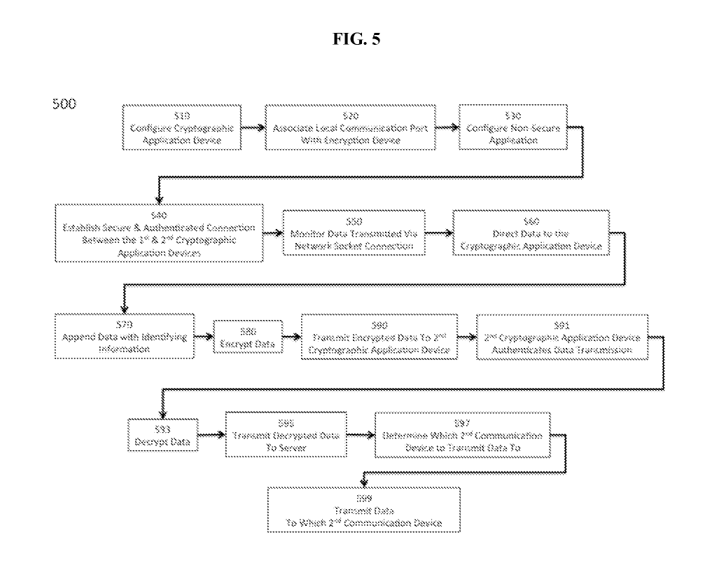

FIG. 5 is a diagram of an exemplary embodiment for a method 500 to establish a secure and protected communication tunnel to transmit electronic data across a communication network from a communication device with a non-secure application to a remote application system comprising the first step of configuring the cryptographic application device 510 with identifying information such as the communication protocol, server names, IP addresses, remote port numbers, etc. for the remote application system. This configuration step may also be auto-configured on the communication device, or provisioned by a network administrator. The cryptographic application device retrieves the identifying information from a database or predefined connection information. The identifying information may include the data's final destination information such as a destination server name, IP address, port number, and device authentication information. The cryptographic application device prepends the data with the destination information and then encrypts the entire data into a data packet.

Next a local communication port from the communication device is configured with the cryptographic application device 520. This enables data to be transmitted from a specific communication port that can be monitored to detect when encrypted and authenticated data needs to be authenticated and decrypted. This also enables a device on the other end of the communication transmission to identify when a communication is from a trusted source for proper authentication and data decryption. For example, the second cryptographic application device can determine when a data transmission from any device is from a trusted source and in need of decryption by recognizing the data transmission from the communication port. This configuration step may also be auto-configured on the communication device, or provisioned by a network administrator.

Next the non-secure application is configured to transmit data through a specific network socket connection 530. The network socket connection constitutes a mechanism for delivering data packets to the appropriate application process, based on a combination of local and remote IP addresses and port numbers. Each socket is mapped by the operating system to a communicating application process. In other words, the non-secure application is configured with the network socket connection for a server set to local-host and a defined port. So when the non-secure application attempts to connect to an external application server, the non-secure application will open up a socket connection to the local-host and the defined port. This enables the monitor to keep track of data transmission from any number of non-secure applications. The monitor will recognize any data transmission from this defined port as one destined for the secure communication tunnel. As such, the monitor will reroute the transmission for encryption and transmission through the secured communication tunnel. This configuration step may also be auto-configured on the communication device, or provisioned by a network administrator.

Next the cryptographic application device establishes a secure communication tunnel, or secure and authenticated connection, to a second cryptographic application device of the remote application system 540. The cryptographic application device is set up to seek a predefined second cryptographic application device within a known remote application system. For example, the cryptographic application device may be programmed to establish connection to a gateway server from a service provider that is dedicated to receiving the encrypted data, authenticating the transmission is from a trusted source, decrypting the data, and forwarding the decrypted data to an end client, or second communication device. Multiple secure communication tunnels may be established at any given time allowing the non-secure application data to traverse any given tunnel, which may depend upon the communication device or application configuration. The configurations regarding which secure communication tunnel an application traverses can be preconfigured or automatic, based on random generation or depending on the network that the remote application system is connected. This configuration step may also be auto-configured on the communication device, or provisioned by a network administrator.

Next a monitor monitors data transmitted through the network socket connection 550. The monitor device monitors the network socket connection for data transmissions from the non-secure application. The monitor device may be a programmable computer, electronic device, or a software application. The monitor device utilizes the network socket connection, such as TCP and UDP sockets to accept incoming connection from the non-secure applications. The monitor continuously proxies each configured non-secure application by monitoring the predefined network socket connections. This works because each non-secure application, such as an email client, is configured to point to the communication device's local IP address and a specific port where the monitor is “listening.”

Next the monitor directs the data to the cryptographic application device 560. Upon detecting a data transmission on a configured socket connection, the monitor will direct the data transmission to the application device. Next the cryptographic application device prepends the data with the identifying information for the remote application system 570. The cryptographic application device retrieves the destination information from a database or predefined connection information. The destination information may include the data's final destination information such as a destination server name, IP address, port number, and device authentication information. The cryptographic application device prepends the non-secure application data with the destination information and next encrypts the entire data into a data packet 580. In short, the cryptographic application device transforms the plaintext data using an encryption algorithm, or a cipher, to make the data unreadable to anyone except those possessing special knowledge, i.e. a key, to decrypt and make the data readable.

Next the encrypted data is transmitted via the secure and authenticated connection to the second cryptographic application device of the remote application system 590. The cryptographic application device transmits the encrypted data via a local port and across the network via the secure communication tunnel. On the other end of the secure communication tunnel is a remote communication port coupled to the second cryptographic application device to receive the encrypted data. The second cryptographic application device authenticates the data transmission as one from a known and trusted source 591 then it transforms the encrypted data using a decryption algorithm, or a key, to make the data readable 593. With the decrypted data, the second cryptographic application device is able to identify the data's final destination information such as a destination device name, IP address, port number, and device authentication information. If decryption of authentication fails, the data packet is dropped. The second cryptographic application device uses the data's final destination information to initiate a connection to an application server within the private network of the remote application system. The second cryptographic application device will also track the connection to the application server and associate it with the first communication device's identifying information such as the IP address and local port number to facilitate communication back to the first communication device. Once the connection to the application server is established, the second cryptographic application device sends the decrypted data to the application server 595.

Next an application server connected to the second cryptographic application device receives the decrypted data 597. The application server may be a software program running to serve the computational or communication tasks of the non-secure application. The application server may also be a physical computer dedicated to running one or more applications to serve the needs of communications devices on the network. The application server may include an email-server, computer, server, switch, gateway, router, database server, file server, mail server, print server, web server, or other electronic device capable of directing electronic data to a communication device. The application server uses the destination information to determine which end device to transmit the decrypted data. For example, the application server may use the device name, IP address, or port number to determine the second communication device to transmit the data.

Next the decrypted data is transmitted 599 to a second communication device coupled to the application server. The second communication device may include an electronic communication or computing device such as a smartphone, tablet, fixed personal computer, mobile computer, or any communication device that enables one computer or electronic device to communicate with another.

Finally, the communication method is reversible so the second communication device can transmit electronic data back to the first communication device over the established secure communication tunnel, as previously described in the specification, thus completing the data transmission interchange.

The embodiments of this invention are especially applicable to standard Android-based applications because Android devices are limited to their data encryption capabilities due to the need to have elevated permissions such as root permissions to install data encryption software. This invention overcomes this issue and does not require root permissions to install and configure non-secure applications with data encryption capabilities. The embodiments of this invention provide a method and system to establish a virtual private network (“VPN”), or a secured and protected network for authenticated and encrypted data transmission to prevent disclosure of private information to unauthorized parties. This invention enables user's of Android-based communication devices to use COTS standard applications without the need to add security features to the applications. In other words, this invention provides secure and authenticated data transmission from a communication device to any public or private network while using existing standard applications such as email, VoIP, internet browsers, ISR applications, video conferencing, telecommuting, inventory tracking and control, etc. without the need to secure or add encryption features into each specific application. This invention provides the opportunity to selectively secure one or more existing applications with configuration changes that can be made at the user-space level of the software stack.

Throughout this description, references were made to devices coupled together in a manner that allows the exchange and interaction of data, such that the operations and processes described may be carried out. For example, the devices may be coupled with electrical circuitry, or through wireless networks that allow the devices to transfer data, receive power, execute the operations described, and provide structural integrity. Reference was also made to communication between a first and second communication device, however the invention is scalable to communication across any number of devices. The invention may also be enabled with more devices than described in the specification. For example, any number of network socket connections, monitors, cryptographic application devices, communication ports, secure communication tunnels, servers, and communication devices may be utilized to enable this invention.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Other modifications, variations, and alternatives are also possible. Accordingly, the claims are intended to cover all such equivalents.

What is claimed is:

1. A method to establish secure communication tunnels to transmit data across a communication network from a communication device with a non-secure application comprising:
configuring the communication device's cryptographic application device with the identifying information of a remote application system;
associating a local communication port of the communication device with the cryptographic application device;
configuring the communication device's non-secure application to transmit data through a specific network socket connection;
establishing secure bi-directional communication tunnels between the communication device and the remote application system;
monitoring data transmitted through the communication device's network socket connection and upon detecting a data transmission on the network socket connection, directing the data transmission to the communication device's cryptographic application device;
using the cryptographic application device to prepend the transmitted data with the remote application system's identifying information and encrypting the transmitted data and prepended identification information into an encrypted data packet;
transmitting the encrypted data packet via the secure communication tunnel to a remote communication port coupled to the remote application system;
using the remote application system's cryptographic application device to first authenticate the data transmission as one from a known and trusted source and then to decrypt the encrypted data;
identifying the data's final destination from the decrypted prepended data and initiating a connection to an appropriate application server of the remote application system;
allowing the remote application system's cryptographic application device to keep track of the connection information of the application server to be associated with the communication device's identifying information;
once the connection to the application server is established, the second cryptographic application device sends the decrypted data to the application server;
using the application server to transmit the decrypted data to a second communication device and;
completing the data transmission exchange when the second communication device transmits data back to the first communication device over the secure bi-directional communication tunnels.

2. The method of claim 1, wherein the identifying information includes the data's final destination information such as a destination server name, IP address, port number, and device authentication information.

3. The method of claim 1, wherein each socket is mapped by the operating system to a communicating application such that the non-secure application is configured with the network socket connection for a server set to local-host and a defined port, so when the non-secure application attempts to connect to an external application server, the non-secure application will open up a socket connection to the local-host and the defined port.

4. The method of claim 1, wherein the monitor keeps track of data transmission from any number of non-secure applications and recognizes any data transmission from the defined port as one destined for the secure communication tunnel, and thus the monitor reroutes the transmission for encryption and transmission through the secured communication tunnel.

5. The method of claim 1, wherein the configurations regarding which secure communication tunnel an application traverses can be preconfigured, automatic, randomly assigned, or dependent on which network the remote application system is connected.

6. The method of claim 1, wherein the monitor device continuously proxies each configured non-secure application by monitoring the predefined network socket connections for data transmissions from the non-secure application utilizing the network socket connection.

7. The method of claim 1, wherein the data packet is dropped if decryption or authentication fails.

8. The method of claim 1, wherein the opportunity to selectively secure one or more non-secure applications with configuration changes are made at the user-space level of the software stack.

9. A system for establishing a secure communication tunnel to transmit data across a communication network from a communication device with a non-secure application with modifications made only within the user-space of the communication device's software stack comprising:
a first communication device;
non-secure applications installed on the first communication device;
network socket connections coupled to the non-secure applications;
monitor devices coupled to the network socket connections;
cryptographic application devices coupled to the monitor devices;
local communication ports coupled to the cryptographic application devices;
secure bi-directional communication tunnels connected to the local communication ports and a remote communication port of a remote application system;
a second cryptographic application device coupled to the remote communication port;
an application server connected to the second cryptographic application device; and
a second communication device coupled to the application server.

10. The system of claim 9, wherein, the communication devices comprise smartphones, tablets, fixed personal computers, mobile computers, or any communication device that enables one device to communicate with another.

11. The system of claim 9, wherein the non-secure applications are commercially available off-the shelf (“COTS”) software applications without an integrated data encryption capability.

12. The system of claim 9, wherein the non-secure applications comprise Email, SIP-based VoIP clients, video conferencing applications or any other software applications in which communicating data across a communication network is a function of the applications.

13. The system of claim 9, wherein the non-secure applications comprise Android-based applications with limited data encryption capabilities requiring elevated permissions such as root permissions to install data encryption software.

14. The system of claim 9, wherein the network socket connections are mapped by the communication device's operating system.

15. The system of claim 9, wherein the cryptographic application device comprises a cryptographic engine comprising of hardware and software that utilizes a data encryption algorithm to secure data from unauthorized access.

16. The system of claim 9, wherein a secure communication tunnel comprises a virtual private network (“VPN”) or any communication connection that uses public infrastructure, such as the Internet, to provide remote users access to a centrally organizational network, or private network.

17. The system of claim 9, wherein the communication ports comprise a serial port or a parallel port with interfaces such as Ethernet, FireWire, USB, and other interfaces intended to interface with a communication device.

18. The system of claim 9, wherein the cryptographic application device comprises the necessary algorithm data path, control processor chips, and software integrated within a server, computer, electronic or communication device within the remote application system.

19. The system of claim 9, wherein the application server comprises an email-server, computer, server, switch, gateway, router, database server, file server, mail server, print server, web server, or other device capable of directing electronic data to communication devices.

20. A non-transient computer-readable medium which stores a set of instructions which when executed performs a method for establishing a secure communication tunnel to transmit data across a communication network from a communication device with a non-secure application comprising:
configuring the communication device's cryptographic application with the identifying information of a remote application system;
associating a local communication port of the communication device with the cryptographic application;
configuring the communication device's non-secure application to transmit data through a specific network socket connection;
establishing secure bi-directional communication tunnels between the communication device and the remote application system;
monitoring data transmitted through the communication device's network socket connection and upon detecting a data transmission on the network socket connection, directing the data transmission to the communication device's cryptographic application;
using the cryptographic application to prepend the transmitted data with the remote application system's identifying information and encrypting the transmitted data and prepended identification information into an encrypted data packet;
transmitting the encrypted data packet via the secure communication tunnel to a remote communication port coupled to the remote application system;
using the remote application system's cryptographic application to first authenticate the data transmission as one from a known and trusted source and then decrypting the encrypted data;
identifying the data's final destination from the decrypted prepended data and initiating a connection to an appropriate application server of the remote application system;
allowing the remote application system's cryptographic application to keep track of the connection information of the application server to be associated with the communication device's identifying information;
once the connection to the application server is established, the second cryptographic application sends the decrypted data to the application server;
using the application server to transmit the decrypted data to a second communication device and;
completing the data transmission exchange when the second communication device transmits data back to the first communication device over the secure bi-directional communication tunnels.
